(19) United States
(12) Patent Application Publication
(10) Pub. No.: US 2016/0307463 A1
(43) Pub. Date: Oct. 20, 2016

(54) COLOR CODED MATH SYSTEM

(71) Applicants: Devon A. Langley, Terre Haute, IN (US); Trevor M. Langley, Terre Haute, IN (US); Caleb Boutell, Terre Haute, IN (US); Elise Boutell, Terre Haute, IN (US); Kira Lenderman, West Terre Haute, IN (US); Aidan Truby, Terre Haute, IN (US); Ellen M. Goodwin, Terre Haute, IN (US)

(72) Inventors: Devon A. Langley, Terre Haute, IN (US); Trevor M. Langley, Terre Haute, IN (US); Caleb Boutell, Terre Haute, IN (US); Elise Boutell, Terre Haute, IN (US); Kira Lenderman, West Terre Haute, IN (US); Aidan Truby, Terre Haute, IN (US); Ellen M. Goodwin, Terre Haute, IN (US)

(21) Appl. No.: 15/131,684

(22) Filed: Apr. 18, 2016

Related U.S. Application Data
(60) Provisional application No. 62/149,021, filed on Apr. 17, 2015.

(51) Int. Cl. G09B 19/02; G09B 5/12

(52) U.S. Cl. CPC G09B 19/025; G09B 5/125

(57) ABSTRACT

A color-coded math system includes a grid for inputting a numeral having at least one digit. The grid is arranged to align the at least one digit thereon. A keypad is provided for inputting the at least one digit of the numeral on the grid. The at least one digit is color-coded on the grid based on a place value of the at least one digit.

### CROSS-REFERENCE TO RELATED APPLICATIONS

This application is a non-provisional of, and claims priority to U.S. Provisional Patent Application Ser. No. 62/149,021, filed Apr. 17, 2015, and titled “COLOR CODED MATH SYSTEM,” the text and drawings of which are herein incorporated by reference.

### TECHNICAL FIELD OF THE DISCLOSED EMBODIMENTS

The embodiments herein generally relate to a math system and, more particularly, to a color-coded math system.

### BACKGROUND OF THE DISCLOSED EMBODIMENTS

Dyslexia is a language disorder that occurs when the brain does not properly recognize and process certain symbols. Most people think of dyslexia as a reading problem, but 50-60% of children with dyslexia struggle with math. A tool is needed to improve the way children challenged by dyslexia learn math concepts so they don't stress over unintentionally reversing or rearranging numbers.

### SUMMARY OF THE DISCLOSED EMBODIMENTS

In one embodiment, a color-coded math system includes a grid for inputting a numeral having at least one digit. The grid is arranged to align the at least one digit thereon. A keypad is provided for inputting the at least one digit of the numeral on the grid. The at least one digit is color-coded on the grid based on a place value of the at least one digit.

In one embodiment, the grid and keypad are displayed on a mobile device.

In one embodiment, the numeral includes a plurality of digits that are color-coded based on the place value of each digit.

In one embodiment, the numeral includes a plurality of digits that are color-coded based on a ROY G. BIV color pattern.

In one embodiment, the numeral is a first numeral and the at least one digit is a first numeral digit. The system enables the first numeral to be positioned in the grid adjacent a second numeral including at least one second numeral digit that is positioned directly adjacent the first numeral digit. The first numeral digit and the second numeral digit are the same color.

In one embodiment, the numeral is aligned on the grid to execute mathematical functions.

In one embodiment, the numeral is arranged on the grid as a fraction.

In one embodiment, a teacher's portal is provided. The teacher's portal is configured to enable a teacher to create an assignment utilizing the numeral placed on the grid.

In one embodiment, the teacher's portal enables the teacher to selectively release the assignment to students.

In one embodiment, a student completes the assignment that has been selectively released to create a completed assignment. The system configured to enable the student to selectively release the completed assignment to the teacher's portal.

In one embodiment, a method for performing mathematics using a color-coded math system is provided. The method includes utilizing a keypad to input a numeral having at least one digit into a grid. The method also includes aligning the at least one digit on the grid. The method also includes color-coding the at least one digit on the grid based on a place value of the at least one digit.

In one embodiment, the method includes displaying the grid and keypad on a mobile device.

In one embodiment, the numeral includes a plurality of digits. The method includes color-coding each of the plurality of digits based on the place value of each digit.

In one embodiment, the numeral includes a plurality of digits. The method includes color-coding each of the plurality of digits based on a ROY G. BIV color pattern.

In one embodiment, the numeral is a first numeral and the at least one digit is a first numeral digit. The method includes positioning the first numeral in the grid adjacent a second numeral including at least one second numeral digit. The method also includes positioning the second numeral digit directly adjacent the first numeral digit. The method also includes color coding the first numeral digit and the second numeral digit as the same color.

In one embodiment, the method also includes aligning the numeral on the grid to execute mathematical functions.

In one embodiment, the method also includes arranging the numeral on the grid as a fraction.

In one embodiment, the method also includes creating an assignment utilizing the numeral placed on the grid. The method also includes placing the assignment on a teacher's portal.

In one embodiment, the method includes selectively releases the assignment to students.

In one embodiment, the method also includes selectively releasing a completed assignment to the teacher's portal.

### DRAWINGS

The patent or application file contains at least one drawing executed in color. Copies of this patent or patent application publication with color drawing(s) will be provided by the Office upon request and payment of the necessary fee.

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawings.

FIG. 1 is a view of a grid and keypad utilized with a color-coded math system in accordance with an embodiment.

FIG. 2 is a view of a fraction setting for a color-coded math system in accordance with an embodiment.

FIG. 3 is a view of a pencil setting for a color-coded math system in accordance with an embodiment.

FIG. 4 is a view of a settings page for a color-coded math system in accordance with an embodiment.

FIG. 5 is a view of a courses menu for a teacher's portal of a color-coded math system in accordance with an embodiment.

FIG. 6 is an add problem menu for a teacher's portal of a color-coded math system in accordance with an embodiment.

FIG. 7 is an edit assignment menu for a teacher's portal of a color-coded math system in accordance with an embodiment.

FIG. 8 is an edit course menu for a teacher's portal of a color-coded math system in accordance with an embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The ROY G. BIV Math System is a computer application designed to improve the way children challenged with dyslexia learn new math concepts so they don't stress over flipping or rearranging digits in a number. In one embodiment, the computer includes a mobile device, for example, a mobile telephone, tablet device, or any device capable of being carried by a person outside of a home to name a few non-limiting examples. The computer includes a processor, memory, and a graphical user interface. In one embodiment, the graphical user interface includes a touch screen display. A program stored in memory operates to display a plurality of graphical objects on the graphical user interface. It will be appreciated that the plurality of graphical objects need not fit on one page of the screen, and may occupy multiple pages on the display. It will also be appreciated that the plurality of graphical objects may be on a current page and accessible via a scrolling action on the display.

The color-coded system keeps digits in place when children do any kind of math operation. The system uses the rainbow color order so children will recognize if they unintentionally move digits because the familiar ROY G. BIV pattern will also be out of order. By assigning a unique color to each place value, it is easier for a child with dyslexia to keep digits lined up correctly. The system may also be useful for children with dysgraphia or any child who struggles with place value. In one embodiment, the system uses the Open Dyslexic font.

The system uses a color-coded system to keep numbers in place using the familiar rainbow color order. Children recognize if they flip digits in their equation because the ROY G. BIV pattern will also be out of order. In a number, the ones place is always Red, the tens and tenths are Orange, the hundreds and hundredths are Yellow, and so on. These details will help children keep each digit where it is meant to be in an equation.

The system allows the user to use a touchscreen and keypad to solve equations. Numbers are neatly organized on a grid. The system uses a color-coded number system which is a way to double check that all digits are in place. The system has a calculator, math games, drills, flash cards, and a place for homework/tests. The system allows teachers to upload worksheets and tests to a child's device. A child can then print, email, or otherwise transfer the results to the teacher and all the work will be color-coded. The system allows uploading where math problems or just numbers are uploaded and converted to the color coding concept. In one embodiment, a child is allowed to select or type the spelled out number, or upload the spelled out number. In one embodiment, the child types the numerals aided by the color coding. In one embodiment, an output allows a student to type in work while color-coded and then print out with or without color. In one embodiment, a typing-only version allows a student to just type a number and the number is automatically displayed in color-coded form. In one embodiment, the system is operable on a website.

In operation, if a teacher is writing notes on a board, a child could use the notebook section of the system to write notes that would be color-coded automatically as the child types, uses a stylus, or writes with his/her finger with the help of the handwriting recognition feature. The numbers would neatly be laid out on graph paper, each digit in its own box, and color-coded by place value following the ROY G. BIV pattern. Children with dyslexia or dysgraphia who have trouble writing clearly, are then able to print out any work for the teacher. Teachers may upload assignments to the tablet so students can complete their work using the color-coded system. Completed work can be printed or emailed to the teacher. Games, number families, and math facts can be used to improve math skills. By assigning a different color to each place value, digits look more distinct from each other and children are less likely to flip, reverse, or rearrange them in their head. And if they do, the child will recognize their error immediately because the rainbow color order (ROY G. BIV) will be out of place.

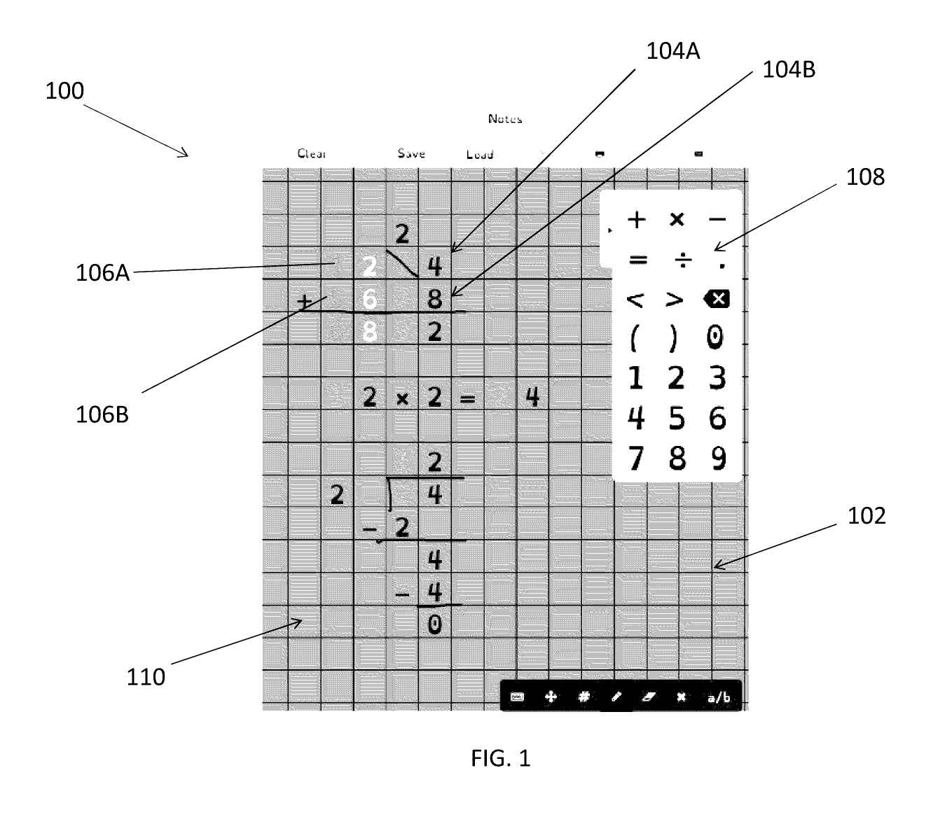

Referring to the drawings, color-coded math system 100 is described. The system 100 includes a grid 102 for inputting a numeral 104 having at least one digit 106. The grid 102 is arranged to align the at least one digit 106 thereon. The grid 102 includes a plurality of blocks 110, wherein the at least one digit 106 may be input. A keypad 108 is provided for inputting the at least one digit 106 of the numeral 104 on the grid 102. In one embodiment, the grid 102 and keypad 108 are displayed on a mobile device, a computer, or the like, as shown in FIG. 1. In particular, a user opens the keypad 108 to have access to digits and mathematical operators that can be input on the grid 102. In operation, the user selects a block 110 of the grid 102 in which the user desires to input the at least one digit 106. The user selects the at least one digit 106 to be input from the keypad 108, which causes the at least one digit 106 to appear in the block 110 of the grid 102. As the user selects additional digits 106 of the numeral 104, the digits 106 appear in the next block 110 of the grid 102, so that a numeral 104 containing a plurality of digits 106 is displayed having each digit 106 in a different block 110.

In one embodiment, the at least one digit 106 is color-coded on the grid 102 based on a place value of the at least one digit 106. In one embodiment, the numeral 104 includes a plurality of digits 106 that are color-coded based on the place value of each digit 106. In one embodiment, the numeral 104 includes a plurality of digits 106 that are color-coded based on a ROY G. BIV color pattern. As used herein, the ROY G. BIV pattern is defined by the colors of the rainbow. Particularly, the ROY G. BIV pattern is as follows: red; orange, yellow; green; blue; indigo; and violet. In one embodiment, the ones place value is colored red; the tens place value is colored orange; the hundreds place value is colored yellow; the thousands place value is colored green; the ten-thousands place value is colored blue; the one-hundred-thousand place value is colored indigo; and the millions place value is colored violet.

In one embodiment, the system 100 utilizes a program that monitors the place value of each digit 106. For example, the program may read a numeral 104 and determine the beginning and end of the numeral 104 based on empty blocks 110 to the right and/or left of the numeral 104 or based on the numeral 104 being positioned at an end of the grid 102. The program identifies the place value of each digit 106. For example, the right-most digit 106 is identified as the one's place value, the digit 106 to the left of the right-most digit 106 is identified as the ten's place value, etc. The digits 106 are then color-coded using the ROY G. BIV pattern described above based on the identified place value of each digit 106. In one embodiment, each digit 106 is colored based on the order in which the digit 106 is entered into the numeral 104. For example, if writing the numeral “345,” the “3” is entered into the grid 102 first and color-coded red. When the second digit 106, the “4” is entered, the “3” is moved to the left to the next block 110. The “4” is then colored red and the “3” is colored orange. When the “5” is entered, the “3” and “4” are both moved left to the next blocks 110. The color of the “3” is then changed to yellow, the color of the “4” is changed to orange, and the “5” is colored red. Accordingly, the color of each digit 106 changes as the place value of the digit 106 is changed within the numeral 104. In one embodiment, the coloring of the digits 106 is performed with a computer, mobile device, or the like.

Accordingly, multiple numerals 104 can be aligned one the grid 102 with place values having matching colors. For example, in one embodiment, a first numeral 104A includes a first numeral digit 106A, and a second numeral 104B includes a second numeral digit 106B. The first numeral digit 106A has the same place value as the second numeral digit 106B. The grid 102 enables the first numeral 104A and the second numeral 104B to be aligned so that the first numeral digit 106A and the second numeral digit 106B are positioned in adjacent blocks 110. In one embodiment, because the first numeral digit 106A and the second numeral digit 106B are of the same place value in their respective numeral 104A, 104B, the first numeral digit 106A and the second numeral digit 106B have the same color based on the ROY G. BIV color pattern. As such, a user can ensure that the first numeral 104A and the second numeral 104B are properly align by ensure that the adjacent first numeral digit 106A and second numeral digit 106B have the same color. In one embodiment, each of the first numeral 104A and second numeral 104B may have multiple digits 106 that can each be aligned by their matching colors. In one embodiment, the color matching allows the user to verify that mathematical equations are properly aligned on the grid 102 per the place values of each digit 106.

The grid 102 enables the user to solve mathematical equations by inputting answers using the keypad 108. As the answers are input by the user, the digits 106 and of numeral 104 are likewise arranged in the ROY G. BIV color pattern. Accordingly, every digit 106 entered in the equation and solution are aligned within the blocks 110 of the grid 102 with matching colors.

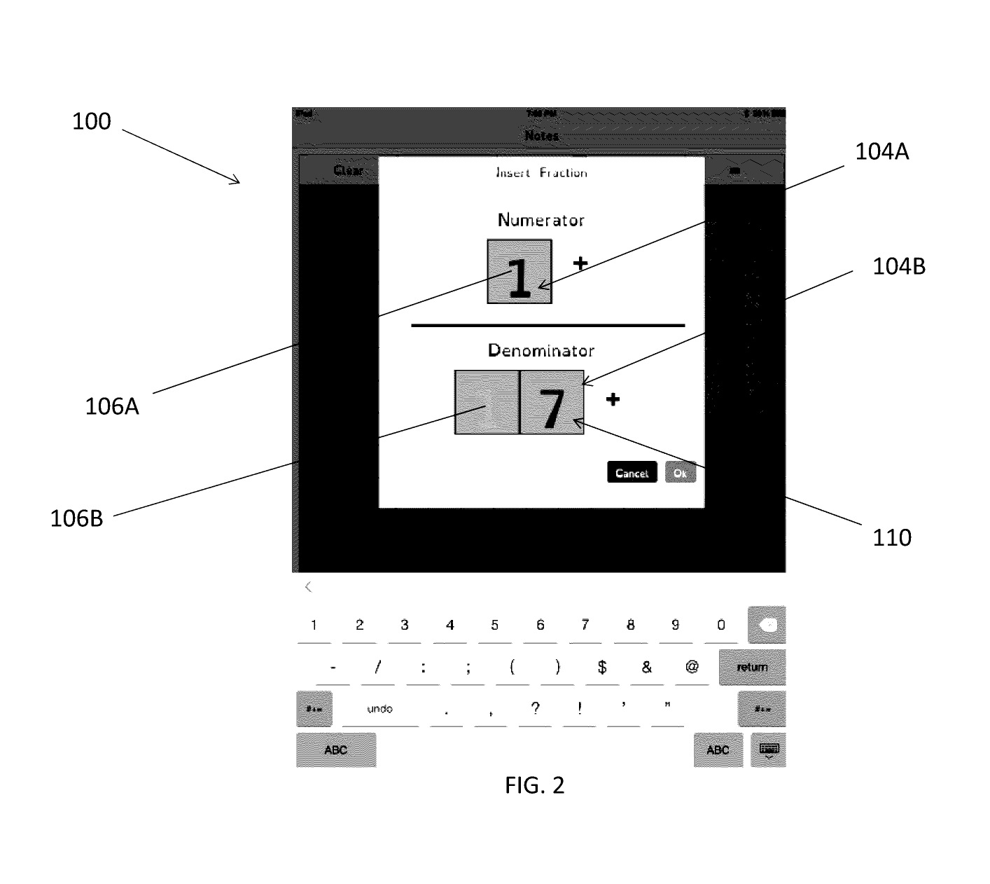

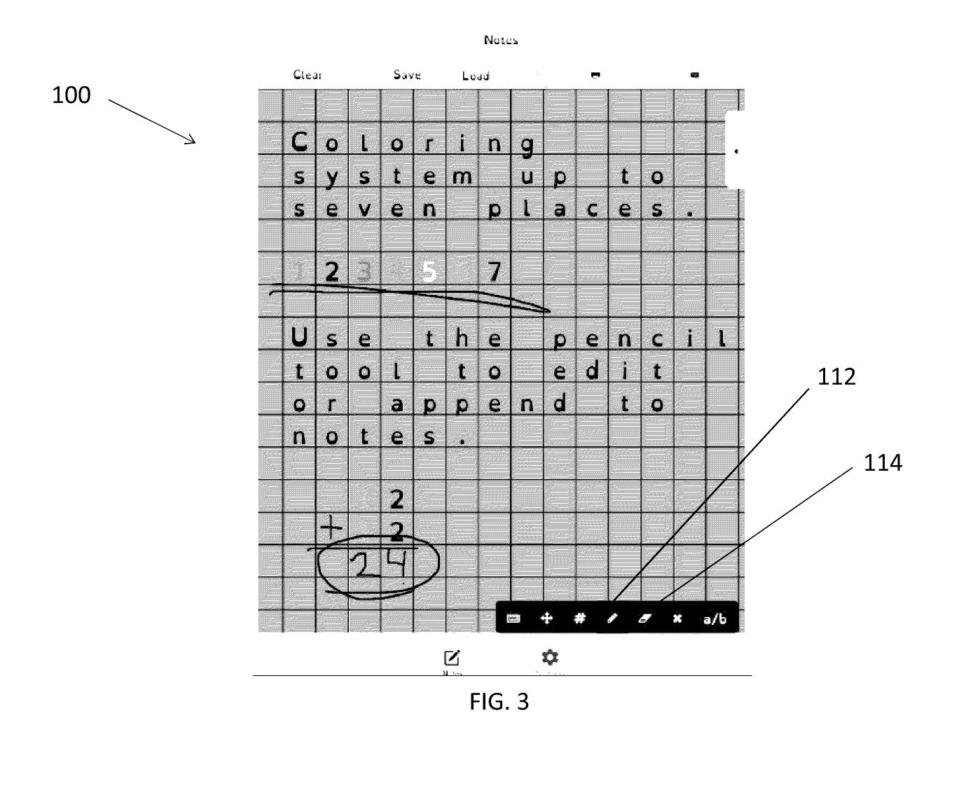

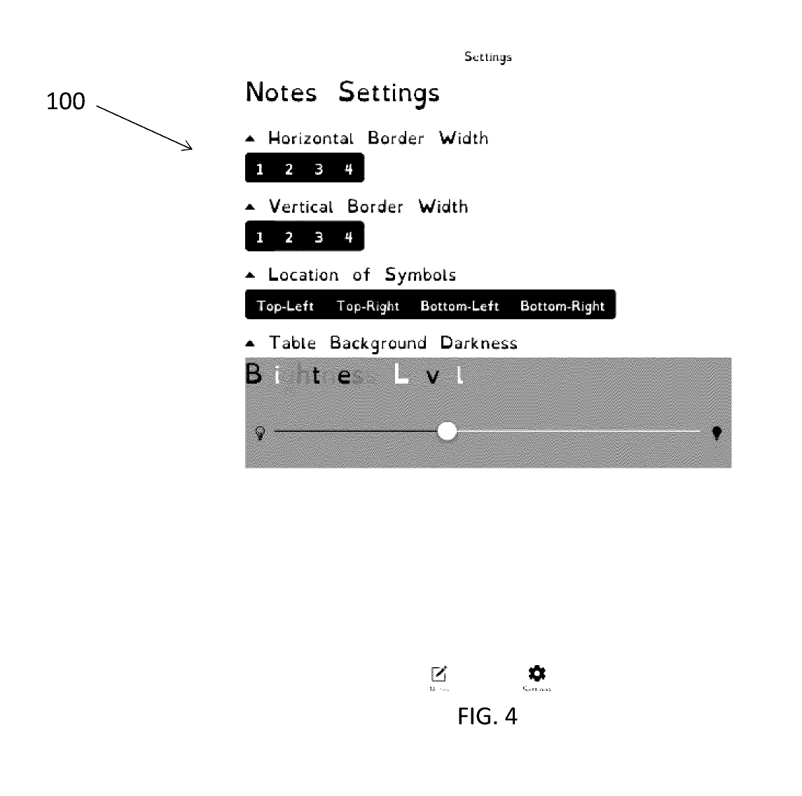

In one embodiment, the system 100 also includes such features as a pencil 112 to draw on the grid 102 and an eraser 114 to erase from the grid 102, as shown in FIG. 3. A user may utilize the pencil 112 and the eraser 114 to make notes on the grid 102. In one embodiment, the grid 102 further enables a user to input fractions into a block 110 of the grid 102 so that more complex equations and solutions may be input into the grid 102, as shown in FIG. 2. In one embodiment, the numerator and denominator of the fraction are likewise color-coded per the ROY G. BIV color pattern. In one embodiment, the user may change settings of the grid 102 and keypad 108, as shown in FIG. 4.

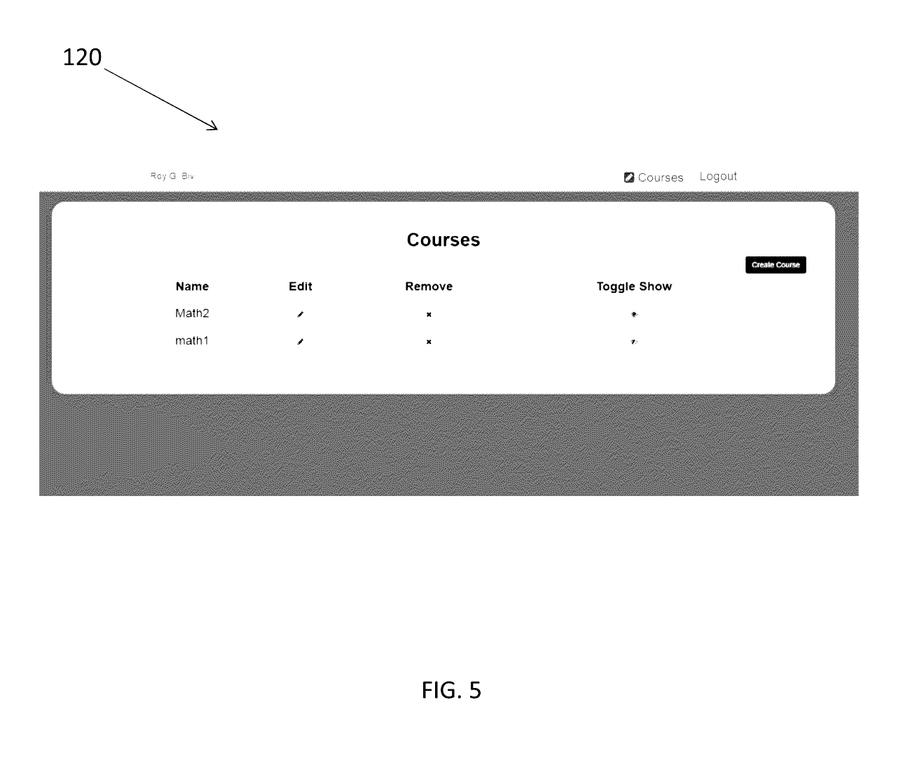

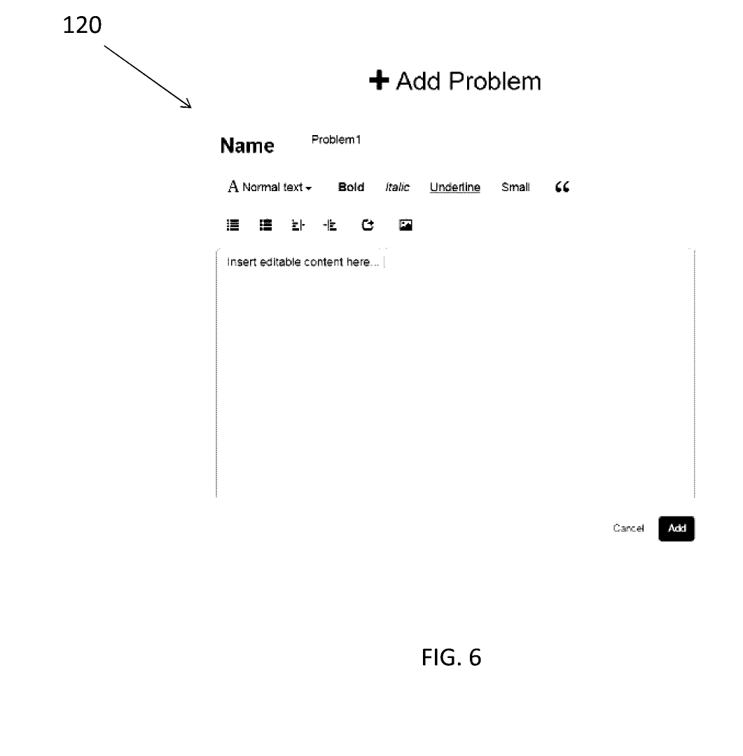

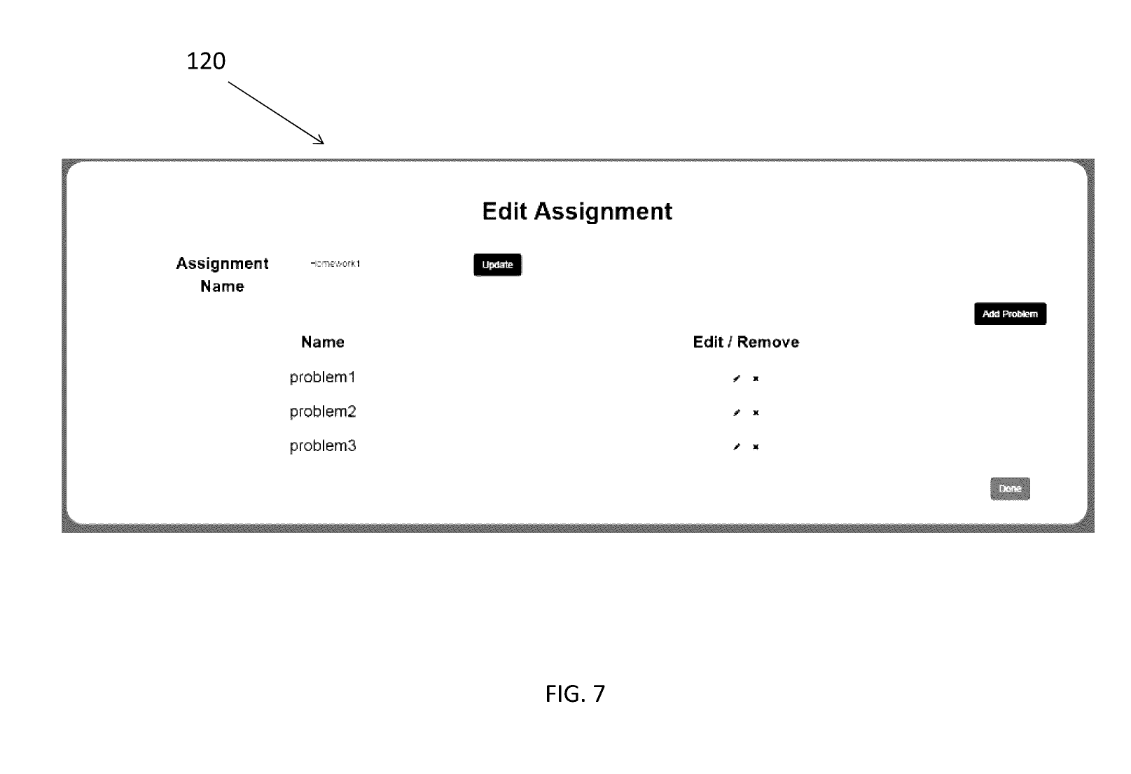

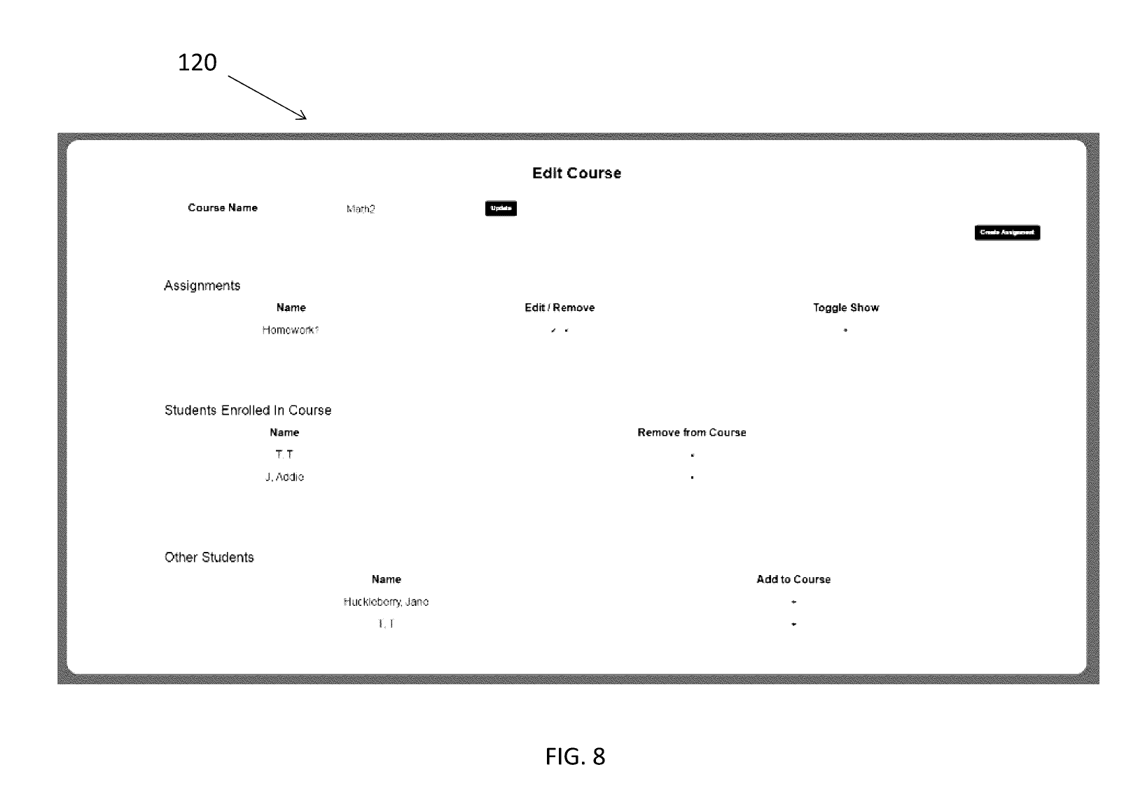

In one embodiment, a teacher's portal 120 is provided within the system 100. The teacher's portal 120 may be accessed using a mobile device, a computer, or the like. The teacher's portal 120 enables a teacher to create courses having assignments that include problems that are input on the grid 102, as shown in FIGS. 5-8. The assignments may include a series of mathematical equations, wherein the digits 106 of each equation are color-coded based on the ROY G. BIV color pattern. The teacher may generate any number of assignments utilizing the grid 102 and the teacher's portal 120. In one embodiment, the teacher may selectively release assignments to students using the teacher's portal 120.

Assignments released by the teacher are accessible by students through the system 100. The assignments may be accessed through a mobile device, a computer, or the like. When an assignment is opened by a student, the assignment appears in the grid 102. The student may then utilize the keypad 108 to complete the assignment on the grid 102. Once completed, the student may save the completed assignment. Completed assignments may then be delivered back to the teacher and made accessible on the teacher's portal 120, thereby enabling the teacher to review and correct the assignment. Reviewed and corrected assignments may then be release back to the student.

While the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

What is claimed is:

1. A color-coded math system comprising:
a grid for inputting a numeral having at least one digit, wherein the grid is arranged to align the at least one digit thereon; and
a keypad for inputting the at least one digit of the numeral on the grid,
wherein the at least one digit is color-coded on the grid based on a place value of the at least one digit.

2. The color-coded math system of claim 1, wherein the grid and keypad are displayed on a mobile device.

3. The color-coded math system of claim 1, wherein the numeral includes a plurality of digits that are color-coded based on the place value of each digit.

4. The color-coded math system of claim 1, wherein the numeral includes a plurality of digits that are color-coded based on a ROY G. BIV color pattern.

5. The color-coded math system of claim 1, wherein the numeral is a first numeral and the at least one digit is a first numeral digit, wherein the system enables the first numeral to be positioned in the grid adjacent a second numeral including at least one second numeral digit that is positioned directly adjacent the first numeral digit, wherein the first numeral digit and the second numeral digit are the same color.

6. The color-coded math system of claim 1, wherein the numeral is aligned on the grid to execute mathematical functions.

7. The color-coded math system of claim 1, wherein the numeral is arranged on the grid as a fraction.

8. The color-coded math system of claim 1 further comprising a teacher's portal, wherein the teacher's portal is configured to enable a teacher to create an assignment utilizing the numeral placed on the grid.

9. The color-coded math system of claim 8, wherein the teacher's portal enables the teacher to selectively release the assignment to students.

10. The color-coded math system of claim 9, wherein a student completes the assignment that has been selectively released to create a completed assignment, the system configured to enable the student to selectively release the completed assignment to the teacher's portal.

11. A method for performing mathematics using a color-coded math system comprising:
utilizing a keypad to input a numeral having at least one digit into a grid;
aligning the at least one digit on the grid; and
color-coding the at least one digit on the grid based on a place value of the at least one digit.

12. The method of claim 11 further comprising displaying the grid and keypad on a mobile device.

13. The method of claim 11, wherein the numeral includes a plurality of digits, the method further comprising color-coding each of the plurality of digits based on the place value of each digit.

14. The method of claim 11, wherein the numeral includes a plurality of digits, the method further comprising color-coding each of the plurality of digits based on a ROY G. BIV color pattern.

15. The method of claim 11, wherein the numeral is a first numeral and the at least one digit is a first numeral digit, the method further comprising:
positioning the first numeral in the grid adjacent a second numeral including at least one second numeral digit;
positioning the second numeral digit directly adjacent the first numeral digit; and
color-coding the first numeral digit and the second numeral digit as the same color.

16. The method of claim 11 further comprising aligning the numeral on the grid to execute mathematical functions.

17. The method of claim 11 further comprising arranging the numeral on the grid as a fraction.

18. The method of claim 11 further comprising:
creating an assignment utilizing the numeral placed on the grid; and
placing the assignment on a teacher's portal.

19. The method of claim 18 further comprising selectively releases the assignment to students.

20. The method of claim 19 further comprising selectively releasing a completed assignment to the teacher's portal.
